(19) United States
(12) Patent Application Publication
(10) Pub. No.: US 2020/0362893 A1
(43) Pub. Date: Nov. 19, 2020

(54) LABYRINTHINE FIXING SYSTEM

(71) Applicant: Magdalena KUBIK, Krezce (PL)

(72) Inventor: Magdalena KUBIK, Krezce (PL)

(21) Appl. No.: 16/765,877

(22) PCT Filed: Nov. 29, 2017
(86) PCT No.: PCT/IB2017/057509

§ 371 Date: May 21, 2020

(51) Int. Cl. F16B 3/00

(52) U.S. Cl. CPC F16B 3/00; F16B 2001/0092

(57) ABSTRACT

The subject of the invention is the physical work, shaped spatially, in the form of the system of two parts with the presented structure arranged in labyrinthine fixing fulfilling a mounting function without locking solution.

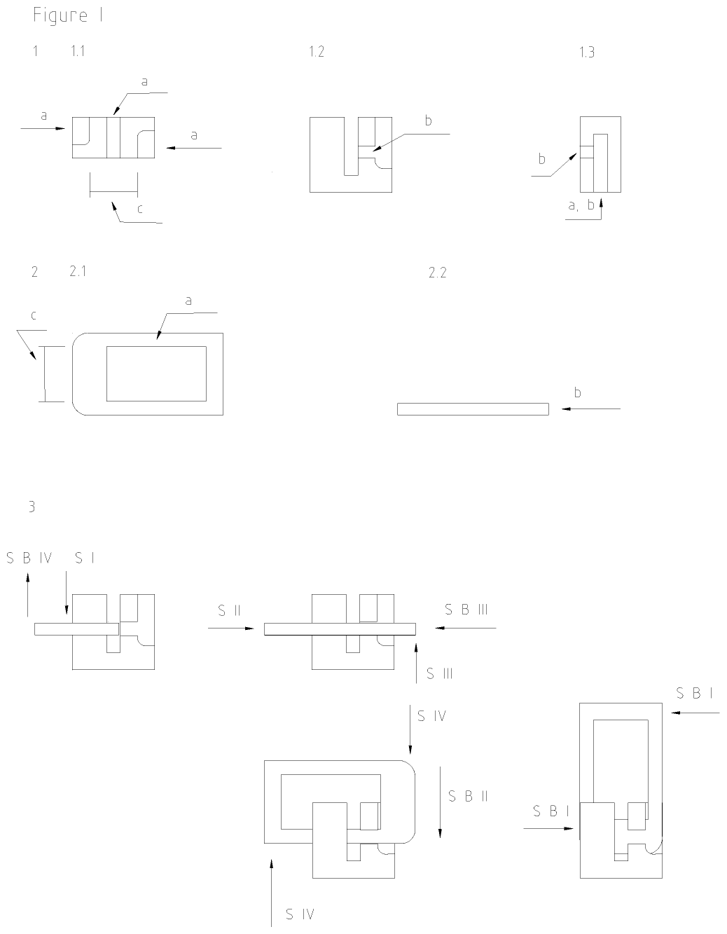

Labyrinthine system of fixing, being the subject of the invention, offers open solution for fixing of the two elements without its unintentional disconnection possibility.

According to the invention the Labyrinthine system of fixing is composed of its two parts: Labyrinth that can be built into a larger or smaller element and Erring Part that can be carried through Labyrinth Part the way described in the present patent description.

The Erring Part of the Labyrinthine system of fixing can be built into a larger or smaller element. Disconnection of fixed Erring and Labyrinth parts of the Labyrinthine system of fixing or in general, elements into which the Erring and Labyrinth parts are built in connected by the Labyrinthine system of fixing requires intentional action by carrying the Erring Part back the same way (described in the present patent description) as it was carried out to be fixed.

Labyrinth part is composed of two identical parts with the opposite orientation, crosswise separated by the channel being the part of the way the Erring Part of the Labyrinthine system of fixing is carried through and back for the purpose of connection or disconnection of two parts of the Labyrinthine system of fixing.

The Erring Part is designed the way to make it possible to carry the Erring Part through Labyrinth Part and place it in vertical orientation in Labyrinth Part fixing Labyrinth and Erring Parts of Labyrinthine system of fixing.

The subject of the invention is the physical work, shaped spatially, in the form of the system of two parts with the presented structure arranged in labyrinthine fixing fulfilling a mounting function without locking solution. The various type of fasteners have been known and used for a long time offering locking solution, screwing, permanent fastening by using fasteners etc. for the purpose of fulfilling mounting function to prevent unintentional disconnection of mounted elements.

Fastener of this type is shown, for example, in the following patent:
JP11166522 Grant number 3757043

Labyrinthine system of fixing, being the subject of the invention, offers open solution for fixing of the two elements without its unintentional disconnection possibility. According to the invention the Labyrinthine system of fixing is composed of its two parts: Labyrinth (FIG. I [1]) that can be built into a larger or smaller element, in the size suitable for the weight of the element into which Labyrinth Part of Labyrinthine system of fixing is built and material of which the part is performed or taste of the designer of the element that demands fixing and Erring Part (FIG. I [2]) that can be carried through Labyrinth Part the way described in the present patent description (it is also possible to carrying Erring Part through Labyrinth Part moving the Labyrinth Part crossing four steps of fixing process and keep Erring Part in the same position) that enables the Erring Part to be mounted in Labyrinth Part or in general in an element possessing the Labyrinth Part built in. The Erring Part of the Labyrinthine system of fixing can be built into a larger or smaller element in the size suitable for the weight of elements into which Erring Part and Labyrinth Part of Labyrinthine system of fixing are built and material of which elements are performed or taste of the designer of the elements that demand fixing. Disconnection of fixed Erring and Labyrinth parts of the Labyrinthine system of fixing or in general, elements into which the Erring and Labyrinth parts are built in connected by the Labyrinthine system of fixing requires intentional action by carrying the Erring Part back the same way as it was carried out to be fixed (it is also possible to carrying Erring Part through Labyrinth Part moving the Labyrinth Part crossing four steps of disconnection process respectively and keep Erring Part in the same position). Fixed parts/elements are freely connected when they are fixed or it can be regulated by the proper matching of the structure dimensions of Labyrinth and Erring Parts. (FIG. I [1,2,3]).

Labyrinth part is composed of two identical parts with the opposite orientation, crosswise separated by the channel being the part of the way the Erring Part of the Labyrinthine system of fixing is carried through and back for the purpose of connection or disconnection of two parts of the Labyrinthine system of fixing. (FIG. I [1]).

Two identical parts of the Labyrinth Part with the opposite orientation, are of the shape presented in FIG. I point 1 and have horizontal channels of the size smaller than [a] and bigger than [b] placed on opposites sides of the Labyrinth Part. Channels are the part of the way the Erring Part of the Labyrinthine system of fixing is carried through and back for the purpose of connection or disconnection of Labyrinth and Erring parts of the Labyrinthine system of fixing. Channels of the size smaller than [a] and bigger than [b] are not placed at the end of the channel crosswise separating Labyrinth Part of the size not less than [a], the way is extended for the purpose of making the way of labyrinthine fixing of the Erring Part of the Labyrinthine system of fixing requiring intentional action while the Erring Part is carried through and back by the marked up way to prevent unintentional disconnection of Labyrinth and Erring Parts fixed by the Labyrinthine system of fixing.

Two identical parts of the Labyrinth Part with the opposite orientation have a shape presented in the FIG. I point 1. The shape of this two identical parts is designed the way to make it possible to fix Erring Part of the Labyrinthine system of fixing—the total size of two identical parts crosswise separated in the middle part is the counterpart of the size [c] (width of the space of the rectangle in the Earing Part)) of the Labyrinthine system of fixing (FIG. I [1.1, 2.1, c]. Two identical parts of the Labyrinth Part with the opposite orientation have the shape of the set squares with the rounded corner (FIG. I [1.1]). Rounded corners strengthen the parts in corners preventing the curving or breaking in this place. In both corners placed in the opposite orientation there are places for Erring Parts of the Labyrinthine system of fixing. In the given places the Erring Parts completes the shapes of the set squares of parts to the shapes of cube/cuboid being blocked by horizontal parts (FIG. I [1.1]) of the set squares shaped parts.

Inside the Labyrinth Part of the Labyrinthine fixing of system there is a space (FIG. I [1.3]) formed by the implementation of other presented solutions concerning the structure of the Labyrinth system of fixing and designed in the size not smaller than [a] for a placement of the Erring Part after carrying it through Labyrinth Part. The space is designed the way unintentional disconnection of Labyrinth and Erring Parts of the Labyrinthine system of fixing is impossible. The shape and size of the Erring Part prevent unintentional disconnection of this two parts (FIG. I [2]). In the case the Erring Part is placed in Labyrinth Part in vertical orientation after its fixing there is no possibility to move the part to the channels placed in opposites sides of the Labyrinth Part in the two identical parts with the opposite orientation because of the size of the Erring Part in its beginning part that is longer than the space from the top to the end of the channels (FIG. I [3]), additionally it is blocked from the back side by the horizontal parts of the set squares shaped parts of the two identical parts of the Labyrinth Part with the opposite orientation and it is blocked by the solution that the way of disconnection of Labyrinth and Erring Part required opposite actions because of the shape of the two identical parts of the Labyrinth Part with the opposite orientation. This solution prevent unintentional disconnection of Labyrinth and Erring Parts fixed by Labyrinthine system of fixing.

The Erring Part is designed the way to make it possible to carry the Erring Part through Labyrinth Part and place it in vertical orientation in Labyrinth Part fixing Labyrinth and Erring Parts of Labyrinthine system of fixing. Dimensions of the Erring Part have their counterparts in Labyrinth Part (FIG. I [1,2]. The counterparts of dimensions of Erring Part can be suitably different in the Labyrinth Part for the purpose of making the carrying of the Erring Part through Labyrinth Part more effortless but should fulfill the criteria that counterpart of [b] size should be smaller than [a] and bigger than [b], counterpart of [a] size should be not less than [a] and counterpart of [c] should be of the size less than [c] size. The Erring Part is designed in the shape of rectangular frame of the given dimensions with its counterparts in Labyrinth Part (FIG. I [1,2]. The Earing Part can be built into a larger or smaller element, in the size suitable for the weight of the element into which Labyrinth Part of Labyrinthine system of fixing is built.

The way of carrying Erring Part through Labyrinth Part is composed of four steps (FIG. [3]). The first is to place the Erring Part in the horizontal orientation presented on the FIG. I point 3 in the place the Labyrinth Part is crosswise separated and carry it through this channel to the level of two horizontal channels of the size smaller than [a] size and bigger then [b] size placed on the opposites sides of the Labyrinth Part in two identical parts of the Labyrinth Part with the opposite orientation. The second is to rotate Erring Part 90 degrees carrying the Erring Part through two horizontal channels of the size smaller than [a] size and bigger then [b] size placed on the opposites sides of the Labyrinth Part, in two identical parts of the Labyrinth Part with the opposite orientation to place it in the space inside the Labyrinth Part in horizontal orientation, perpendicularly to the Labyrinth Part. The third step it to rotate Erring Part placed in the space inside the Labyrinth Part in the horizontal orientation perpendicularly to the Labyrinth Part 90 degrees to place it in a parallel position to the Labyrinth Part. The fourth step is to rotate Erring Part 90 degrees and place it in the vertical orientation in Labyrinth Part. The disconnection of Labyrinth and Erring Parts fixed by Labyrinthine system of fixing is only possible by carrying back the Erring Part through Labyrinth Part the way it was carried out to be fixed (it is also possible to carry Erring Part through Labyrinth Part moving the Labyrinth Part crossing four steps of fixing process keeping Erring Part in the same position). In the first step the size not less than [a] of the channel crosswise separating the Labyrinth Part allows the Erring Part to be curried through this channel in the horizontal position in the orientation of [b] size of the Erring Part. In this case the Erring Part must to be rotate 90 degrees at the level of two horizontal channels of the size smaller than [a] and bigger than [b] placed on the opposites sides of the Labyrinth Part in two identical parts of the Labyrinth Part with the opposite orientation to enter the second step (FIG. [3]).

The way of carrying back the Erring Part through Labyrinth Part is composed of four steps (FIG. [3]). The first step is to rotate fixed Erring Part 90 degrees and place it in the horizontal orientation, parallel to the Labyrinth Part. The second step is to rotate the Erring Part 90 degrees to place it in the horizontal orientation perpendicularly to the Labyrinth Part. The third step is to carry it through the space inside Labyrinth Part to the level of two horizontal channels of the size smaller than [a] and bigger than [b] placed on the opposites sides of the Labyrinth part in two identical parts of the Labyrinth Part with the opposite orientation and to rotate Erring Part 90 degrees carrying the Erring Part through two horizontal channels of the size smaller than [a] and bigger than [b] placed on the opposites sides of the two parts of the Labyrinth Part with the opposite orientation to place it in the channel of the size smaller than [a] and bigger than [b] the Labyrinth Part is crosswise separated. The fourth step is to carry Erring Part through this channel to the top for the purpose of disconnection of Erring and Labyrinth Parts or rotate it 90 degrees and carry Erring Part through this channel to the top for the purpose of disconnection of Erring and Labyrinth Part in the orientation of [b] size of the Erring Part (it is also possible to carrying back Erring Part through Labyrinth Part moving the Labyrinth Part crossing four steps of disconnection process keeping Erring Part in the same position).

What I claim are:

1. Labyrinthine system of fixing composed of its two parts: Labyrinth (FIG. I [1]) and Erring Part (FIG. I [2]) significant by this that the structure of its parts arranged in Labyrinthine system of fixing fulfills mounting function (FIG. I [3]) of two elements;

2. Labyrinthine system of fixing assembly of claim 1, significant by this that the structure of the Labyrinth Part (FIG. I [1]) enables the Labyrinth Part to be permanently or temporarily built into a larger or smaller element according to the design of this element, in the size suitable for the parameters of the elements that demand fixing.

3. Labyrinthine system of fixing assembly of claim 1, significant by this that the structure of the Erring Part (FIG. I [2]) enables the Erring Part to be permanently or temporarily built into a larger or smaller element according to the design of this element, in the size suitable for the parameters of the elements that demand fixing.

4. Labyrinthine system of fixing assembly of claim 1, significant by this that the labyrinth structure of Labyrinth Part (FIG. I [1]) of Labyrinthine system of fixing enables the Labyrinth Part and Erring Part to be connected without locking solution and disconnected only by the solution required intentional actions during carrying the Erring Part through Labyrinth Part and back connecting or disconnecting parts/elements (FIG. I [3]).

5. Labyrinthine system of fixing assembly of claim 4, significant by this that Labyrinth Part (FIG. I [1]) composed of two identical parts with the opposite orientation, crosswise separated by the channel of the size not less than [a] being the part of the way the Erring Part of the Labyrinthine system of fixing is carried through the Labyrinth Part and back for the purpose of connection or disconnection of two parts of the Labyrinthine system of fixing in the first step (FIG. I [3]) and channels of the size smaller than [a] and bigger than [b] placed on opposites sides of the Labyrinth Part in the identical parts of the opposite orientation being the part of the way, the Erring Part of the Labyrinthine system of fixing is carried through Labyrinth Part and back for the purpose of connection or disconnection of two parts of the Labyrinthine system of fixing in the second step (FIG. I [3]) enables the Erring Part to be placed in the space inside the Labyrinthine Part of the Labyrinthine system of fixing by carrying Erring Part through Labyrinth Part fulfilling requirements of the opposite actions concerning Erring Parts (the Erring Part have to be carried simultaneously through two channels placed on the opposite sides). The requirements of opposite actions concerning Erring Part placed finally in the vertical position (FIG. I [3]) prevent disconnection of Labyrinth and Erring Part the way different than the way the parts were fixed because of the orientation the Erring part is placed in Labyrinth Part when two parts are fixed.

6. Labyrinthine system of fixing assembly of claim 5, significant by this that two identical parts of the Labyrinth Part with the opposite orientation of the shape presented in FIG. I point 1 with horizontal channels of the size smaller than [a] and bigger than [b] placed on the opposites sides of the Labyrinth Part, placed not at the end of the channel crosswise separating Labyrinth Part enable the extended way to require intentional action while the Erring Part is carried through and back the marked up way to prevent unintentional disconnection of Labyrinth and Erring parts fixed by the Labyrinthine system of fixing.

7. Labyrinthine system of fixing assembly of claim 5, significant by this that two identical parts of the Labyrinth Part with the opposite orientation of the shape presented in FIG. I point 1 with horizontal channels of the size smaller than [a] and bigger than [b] placed on the opposites sides of the Labyrinth Part prevent Erring Part placed in parallel position to the Labyrinth Part to be carried back through horizontal channels without its rotation to the perpendicular to the Labyrinth Part position. This solution prevent unintentional disconnection of Labyrinth and Erring Parts fixed by the Labyrinthine system of fixing.

8. Labyrinthine system of fixing assembly of claim 5, significant by this that two identical parts of the Labyrinth Part with the opposite orientation have shape of set squares (FIG. I [1]). The shape of this two identical parts enables the Erring Part of the Labyrinthine system of fixing to be fixed by placing it in vertical position in Labyrinthine Part (the total size of two identical parts crosswise separated in the middle part is the counterpart of the size [c] (width of the space of the rectangle in the Earing Part)) of the Erring Part of the Labyrinthine system of fixing (FIG. I [1.1, 2.1, c])).

9. Labyrinthine system of fixing assembly of claim 5, significant by this that the two identical parts of the Labyrinth Part with the opposite orientation have the shape of the set squares with rounded corner (FIG. I [1.1]). The rounded corners strengthen the parts in corners preventing the curving or breaking in this places. In both corners placed in the opposite orientation there are places for Erring Part of the Labyrinthine system of fixing. In the given places the Erring Part completes the shape of the set squares of parts to the shape of cube/cuboid being blocked by horizontal parts (FIG. I [1.1] of the set squares shaped parts.

10. Labyrinthine system of fixing assembly of claim 4, significant by this that the space inside the Labyrinth Part being formed by the implementation of other presented solutions concerning the structure of the Labyrinth system of fixing and designed in the size not smaller than [a] (FIG. I [1.3]) for a placement of the Erring Part after carrying it through Labyrinth Part enables Labyrinthine system of fixing to prevent unintentional disconnection of Labyrinth and Erring Parts. In the case the Erring Part is placed in Labyrinth Part in vertical orientation after its fixing there is no possibility to move the Part to the channels placed in opposites sides of the Labyrinth Part in the identical parts with the opposite orientation because of the size of the Erring Part in its beginning part that is longer than the space from the top to the level of the end of the channels (FIG. I [3]) additionally it is blocked from the back side by the horizontal parts of the set squares shaped parts of the two identical parts of the Labyrinth Part with the opposite orientation and it is blocked by the solution that the way of disconnection of Labyrinth and Erring Part required opposite actions because of the shape of the two identical parts of the Labyrinth Part with the opposite orientation.

11. Labyrinthine system of fixing assembly of claim 1, significant by this that the shape of Erring Part of rectangular frame of the given dimensions with its counterparts in Labyrinth Part (FIG. I [1,2] enables the Erring Part to be carried through Labyrinth Part and to be placed in vertical orientation in Labyrinth Part fixing Labyrinth and Erring Parts of Labyrinthine system of fixing.

12. Labyrinthine system of fixing assembly of claim 1, significant by this that the shape and the size of the Erring Part enables Labyrinthine system of fixing to prevent unintentional disconnection of Labyrinthine and Erring parts (FIG. I [2]).

13. Labyrinthine system of fixing assembly of claim 1, significant by this that disconnection of fixed Erring and Labyrinth Parts of the Labyrinthine system of fixing or in general elements into which the Erring and Labyrinth Parts are built in connected by the Labyrinthine system of fixing requires intentional action by carrying the Erring Part back the same way as it was carried out to be fixed. Fixed parts/elements are freely connected when they are fixed or it can be regulated by the proper matching of the structure dimensions of Labyrinth and Erring Parts. (FIG. I [1,2,3]).

14. Labyrinthine system of fixing assembly of claim 1, significant by this that the way of carrying Erring Part through Labyrinth Part is composed of four steps (FIG. I [3]). The first is to place the Erring Part in the horizontal orientation presented on the FIG. I point 3 in the place the Labyrinth Part is crosswise separated and carry it through this channel to the level of two horizontal channels of the size smaller than [a] and bigger than [b] placed on the opposites sides of the Labyrinth Part in two identical parts of the Labyrinth Part with the opposite orientation. The second is to rotate Erring Part 90 degrees carrying the Erring Part through two horizontal channels of the size smaller than [a] and bigger than [b] placed on the opposites sides of the Labyrinth Part in two identical parts of the Labyrinth Part with the opposite orientation to place it in the space inside the Labyrinth Part in horizontal orientation, perpendicularly to the Labyrinth Part. The third step is to rotate Erring Part placed in the space inside the Labyrinth Part in the horizontal orientation perpendicularly to the Labyrinth Part 90 degrees to place it in a parallel position to the Labyrinth Part. The fourth step is to rotate Erring Part 90 degrees and place it in the vertical orientation in Labyrinth Part. The disconnection of Labyrinth and Erring Parts fixed by Labyrinthine system of fixing is only possible by carrying back the Erring Part through Labyrinth Part the way it was carried through to be fixed. In the first step the size not less than [a] of the channel crosswise separating the Labyrinth Part allows the Erring Part to be curried through this channel in the horizontal position in the orientation of [b] size of the Erring Part. In this case the Erring Part must to be rotate 90 degrees at the level of two horizontal channels of the size smaller than [a] and bigger than [b] placed on the opposites sides of the Labyrinth Part in two identical parts of the Labyrinth Part with the opposite orientation to enter the second step (FIG. [3]).

15. Labyrinthine system of fixing assembly of claim 13 significant by this that the structure of Labyrinthine system of fixing enables the Erring Part to be carried through Labyrinth Part by moving the Labyrinth Part crossing four steps of fixing process keeping Erring Part in the same position.

16. Labyrinthine system of fixing assembly of claim 1, significant by this that the way of carrying back the Erring Part through Labyrinth Part is composed of four steps (FIG. [3]). The first step is to rotate fixed Erring Part 90 degrees and place it in the horizontal orientation, parallel to the Labyrinth Part. The second step is to rotate the Erring Part 90 degrees to place it in the horizontal orientation perpendicularly to the Labyrinth Part. The third step is to carry it through the space inside Labyrinth Part to the level of two horizontal channels of the size smaller than [a] and bigger than [b] placed on the opposites sides of the Labyrinth Part in two identical parts of the Labyrinth Part with the opposite orientation and to rotate Erring Part 90 degrees carrying the Erring Part through two horizontal channels of the size smaller than [a] and bigger than [b] placed on the opposites sides of two parts of the Labyrinth Part with the opposite orientation to place it in the channel of the size not less than [a] the Labyrinth Part is crosswise separated. The fourth step is to carry Erring Part through this channel to the top for the purpose of disconnection of Erring and Labyrinth Parts or rotate it 90 degrees and carry Erring Part through this channel to the top for the purpose of disconnection of Erring and Labyrinth Part in the orientation of [b] size of the Erring Part.

17. Labyrinthine system of fixing assembly of claim 13, significant by this that the structure of Labyrinthine system of fixing enables the Erring Part to be carried back through Labyrinth Part by moving the Labyrinth Part crossing four steps of fixing process keeping Erring Part in the same position.
